(19) United States
(12) Patent Application Publication
(10) Pub. No.: US 2010/0124211 A1
(43) Pub. Date: May 20, 2010

(54) REDUCING AN OCCURRENCE OF A VOIP CALL ON HOLD FROM BEING DROPPED IN EV-DO SYSTEMS

(75) Inventors: Ajith Tom Payyappilly, San Diego, CA (US); Deepak Khandelwal, San Diego, CA (US); Lei Shen, Beijing (CN); Reza Shahidi, San Diego, CA (US)

Correspondence Address: QUALCOMM INCORPORATED, 5775 MOREHOUSE DR., SAN DIEGO, CA, 92121, US

(73) Assignee: QUALCOMM incorporated, San Diego, CA (US)

(21) Appl. No.: 12/272,440

(22) Filed: Nov. 17, 2008

(51) Int. Cl. H04W 76/00

(52) U.S. Cl. 370/338

(57) ABSTRACT

Methods, apparatuses, and systems for reducing an occurrence of a Voice over Internet Protocol (VoIP) call from being disconnected in an Evolution Data Only (EV-DO) system are disclosed. The VoIP call is placed on hold and at least one keep-alive packet is issued to prevent a radio link from disconnecting. The at least one keep-alive packet is issued at least while the VoIP call associated with the radio link is on hold and is configured to reset a dormancy timer for the call at one or more network entities.

### FIELD OF DISCLOSURE

Embodiments of the invention relate to communications in a telecommunications system, and more particularly to reducing an occurrence of a VoIP call on hold from being dropped in an EV-DO system.

### BACKGROUND

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

Evolution-Data Optimized (EV-DO) is a telecommunications standard for the wireless transmission of data through radio signals, typically for broadband Internet access. EV-DO utilizes multiplexing techniques including CDMA as well as TDMA to maximize both individual user's throughput and the overall system throughput. EV-DO is standardized by the 3rd Generation Partnership Project 2 (3GPP2) as part of the CDMA2000 family of standards. EV-DO was designed as an evolution of the CDMA2000 (IS-2000) standard that would support high data rates and could be deployed alongside a wireless carrier's voice services. EV-DO was designed to be operated as an end-to-end as an IP based network. However, there have been several revisions of the standard, starting with Revision 0 (Rev. 0). Rev. 0 was later expanded upon with Revision A (Rev. A) in order to support QoS (to improve latency) and higher data rates on both the forward and reverse link. Subsequently, Revision B (Rev. B) was published and includes the ability to bundle multiple carriers to achieve even higher rates and lower latencies. Accordingly, a version of the 1xEV-DO specification, entitled “CDMA2000 High Rate Packet Data Air Interface Specification, the 1xEV-DO Rev. A specification, and 1xEV-DO Rev. B specification are hereby incorporated by reference in its entirety.

Voice-over-Internet protocol (VoIP) is a protocol optimized for the transmission of audio data through packet-switched networks, such as the Internet. VoIP systems carry telephony signals as digital audio, typically reduced in data rate using speech data compression techniques, encapsulated in a data-packet stream over IP. VoIP systems may also be referred to as IP telephony, Internet telephony, voice over broadband, broadband telephony, and broadband phone. However, when VoIP is integrated with an EV-DO system various challenges are encountered.

On a 1x EV-DO system, when an application sends or receives data to an Access Terminal, a data call is said to be dormant when the end-to-end PPP session between the Access Terminal and the PDSN is up, but at the same time at the radio layer, the traffic channel is down. Therefore, when no exchange of data to and/or from the Access Terminal occurs, precious radio resources are preserved while the data call remains dormant. During this dormant period, since the PPP link is maintained, the IP layer and any layers located above, including the application layer at both ends, are unaware that the radio layer connection between the Access Terminal and the Access Network is not maintained. Therefore, whenever an application sends or receives data, a radio traffic-channel is established/re-established between the Access Terminal and the Access Network. The application and the access terminal come out of dormancy and go back to an Active state when data is exchanged by the application. The period of inactivity after which the radio traffic-channel is torn down is called the dormancy timer. The dormancy timer may be configured and maintained by both the Access Terminal and the Access Network.

However, a VoIP call over an EV-DO-Rev A network that is placed on hold by a user will be dropped if the call is placed on hold for a duration of time that exceeds the Access Network or Access Terminal's traffic channel dormancy time threshold.

### SUMMARY

Exemplary embodiments of the invention are directed to systems and methods for reducing an occurrence of a Voice over Internet Protocol (VoIP) call from being disconnected in an Evolution Data Only (EV-DO) system

Accordingly an embodiment of the invention can include a method for reducing an occurrence of a Voice over Internet Protocol (VoIP) call from being disconnected in an Evolution Data Only (EV-DO) system comprising: placing the VoIP call on hold; and issuing at least one keep-alive packet to prevent a radio link from disconnecting, at least while the VoIP call associated with the radio link is on hold, wherein the at least one keep-alive packet is configured to reset a dormancy timer for the call at one or more network entities.

Another embodiment can include an apparatus comprising: logic configured to place a Voice over Internet Protocol (VoIP) call on hold in an Evolution Data Only (EV-DO) system; and logic configured to issue at least one keep-alive packet to prevent a radio link from disconnecting, at least while the VoIP call associated with the radio link is on hold, wherein the at least one keep-alive packet is configured to reset a dormancy timer for the call at one or more network entities.

Another embodiment can include a computer-readable medium comprising instructions for reducing an occurrence of a Voice over Internet Protocol (VoIP) call from being disconnected in an Evolution Data Only (EV-DO) system, which, when executed by a machine, cause the machine to perform operations, the instructions comprising: instruction to place the VoIP call on hold; and instructions to issue at least one keep-alive packet to prevent a radio link from disconnecting, at least while the VoIP call associated with the radio link is on hold, wherein the at least one keep-alive packet is configured to reset a dormancy timer for the call at one or more network entities.

Another embodiment can include an apparatus comprising: means for placing a Voice over Internet Protocol (VoIP) call on hold in an Evolution Data Only (EV-DO) system; and means for issuing at least one keep-alive packet to prevent a radio link from disconnecting, at least while the VoIP call associated with the radio link is on hold, wherein the at least one keep-alive packet is configured to reset a dormancy timer for the call at one or more network entities.

### BRIEF DESCRIPTION OF THE DRAWINGS

The accompanying drawings are presented to aid in the description of embodiments of the invention and are provided solely for illustration of the embodiments and not limitation thereof.

FIG. 1 a diagram of a wireless network architecture that supports access terminals and access networks in accordance with at least one embodiment of the invention.

FIG. 2 illustrates the carrier network according to an embodiment of the invention.

FIG. 3 is an illustration of an access terminal in accordance with at least one embodiment of the invention.

FIG. 4 is an illustration of an exemplary layering architecture in an EV-DO system where a VoIP call is placed on hold.

FIG. 5 is an illustration of a process flow for an exemplary embodiment of the call on hold process.

FIG. 6 is an illustration of a process flow for another exemplary embodiment of the call on hold process.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal may be any data device that communicates through a wireless channel or through a wired channel, for example using fiber optic or coaxial cables. An access terminal may further be any of a number of types of devices including but not limited to PC card, compact flash, external or internal modem, or wireless. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

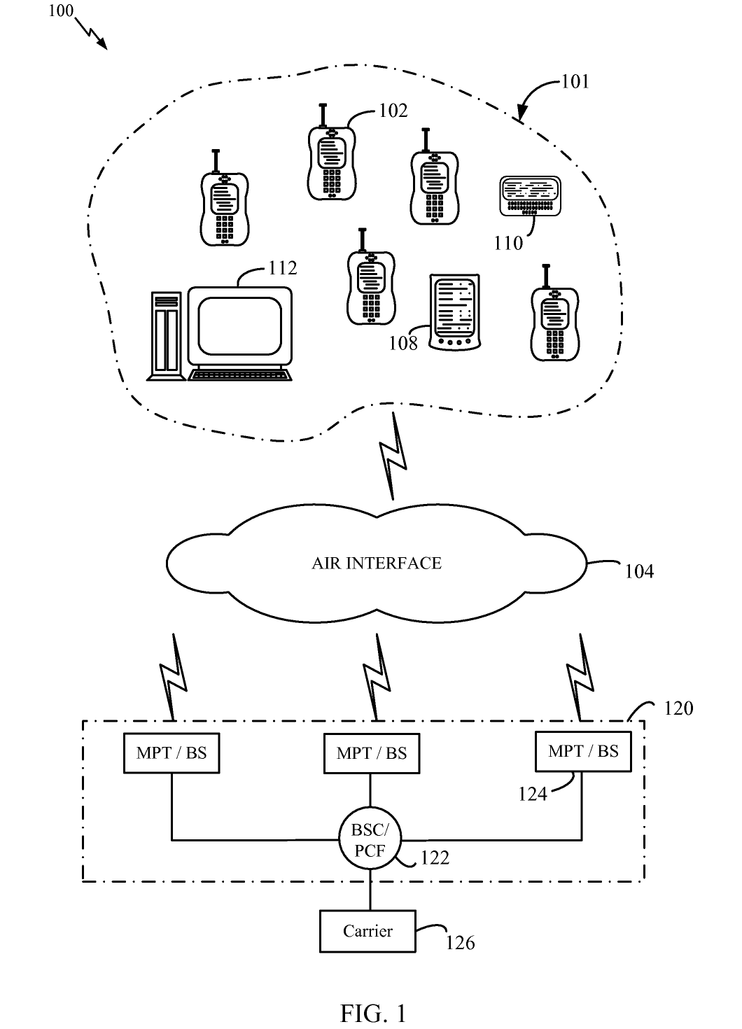

FIG. 1 illustrates a block diagram of one exemplary embodiment of a wireless system 100 in accordance with at least one embodiment of the invention. System 100 can contain access terminals 101 in communication across an air interface 104 with an access network or radio access network (RAN) 120 that can connect the access terminals 101 to network equipment providing data connectivity between a packet switched data network (e.g., an intranet, the Internet, and/or carrier network 126) and the access terminals 102, 108, 110, 112. As shown here, the access terminals 101 can be a cellular telephone 102, a personal digital assistant 108, a pager 110, which is shown here as a two-way text pager, or even a separate computer platform 112 (desktop/notebook) that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node 160 (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the invention is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

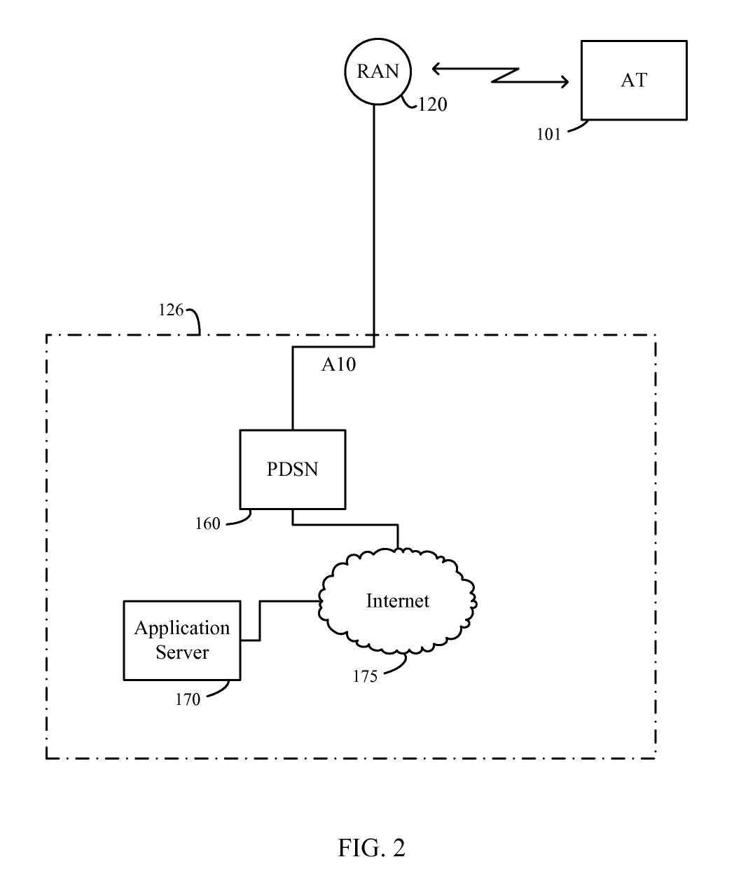

FIG. 2 illustrates the carrier network 126 according to an embodiment of the invention. In the embodiment of FIG. 2, the carrier network 126 includes a packet data serving node (PDSN) 160, an application server 170 and an Internet 175. However, application server 170 and other components may be located outside the carrier network in alternative embodiments. The PDSN 160 provides access to the Internet 175, intranets and/or remote servers (e.g., application server 170) for mobile stations (e.g., access terminals, such as 102, 108, 110, 112 from FIG. 1) utilizing, for example, a CDMA2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2, the PDSN 160 may communicate with the RAN 120 (e.g., the BSC/PCF 122) via a conventional A10 connection. The A10 connection is well-known in the art and will not be described further for the sake of brevity.

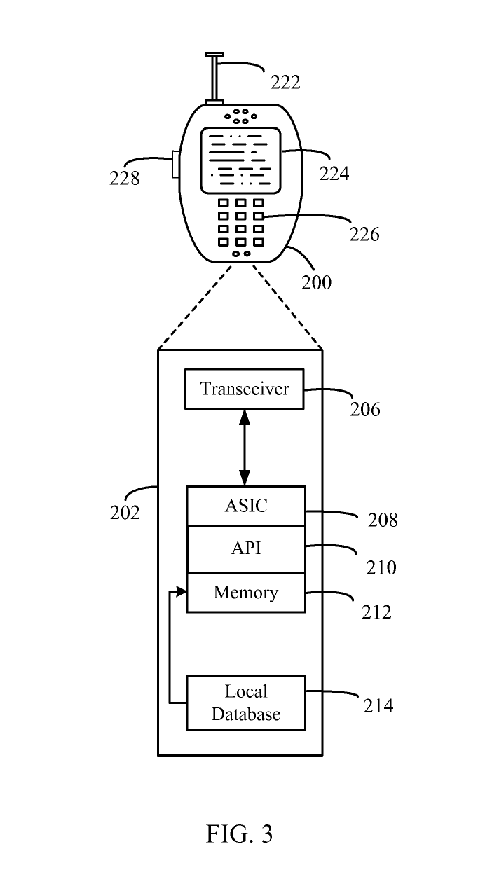

Referring to FIG. 3, an access terminal 101, (here a wireless device), such as a cellular telephone 102, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database/memory 214 that can hold applications and/or data not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 (which may include a hold button) among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the invention is not limited to the illustrated features or arrangement.

The wireless communication between the access terminal 101 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the access terminal 101, MPT/BS 124, and BSC/PCF 122. The BSC/PCF 122 can be connected to multiple data networks such as the carrier network 126, PSTN, the Internet, a virtual private network, and the like, thus allowing the access terminal 101 access to a broader communication network. As discussed in the foregoing and known in the art, voice transmission and/or data can be transmitted to the access terminals 101 from the RAN 120 using a variety of networks and configurations. Accordingly, the illustrations provided herein are not intended to limit the embodiments of the invention and are merely to aid in the description of aspects of embodiments of the invention.

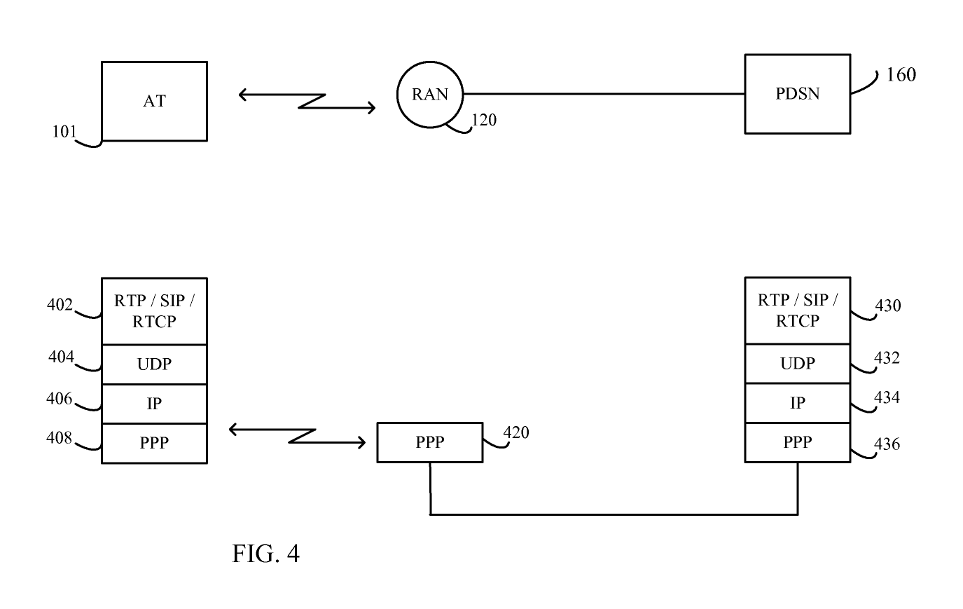

FIG. 4 illustrates the exemplary layering architecture for AT 101, RAN 120 and PDSN 160 in an EV-DO system where a VoIP call is placed on hold. Each layer of the TCP/IP architecture includes one or more protocols that perform the layer's functionality. Each protocol may be individually negotiated.

Application layers 402, 430 may provide multiple applications including RTP, SIP, and RTCP. Real-time Transport Protocol (RTP) defines a standardized packet format for delivering audio and video over the Internet. Session Initiation Protocol (SIP) is a signaling protocol, utilized for setting up and tearing down multimedia communication sessions, such as voice and video calls over the Internet. However, other feasible application examples may include video conferencing, streaming multimedia distribution, instant messaging, presence information and online games. Real-time Transport Control Protocol (RTCP) is a sister protocol of RTP. RTCP provides out-of-band control information for an RTP flow. The primary function of RTCP is to provide feedback on the QoS being provided by RTP. RTCP gathers statistics on a media connection and information such as bytes sent, packets sent, lost packets, jitter, feedback and round trip delay.

Referring to FIG. 4, transport layers 404, 432 at AT 101 and PDSN 160, respectively, may provide a User Datagram Protocol (UDP). Network layers 406, 434 at AT 101 and PDSN 160, respectively, may provide an IP layer. Data link layers 408, 420, 436 at AT 101 and PDSN 160, respectively, may provide a Point-to-Point Protocol (PPP). PPP is a data link protocol commonly used to establish a connection between two nodes over serial cable, phone line, trunk line, cellular telephone, specialized radio links, or fiber optic links.

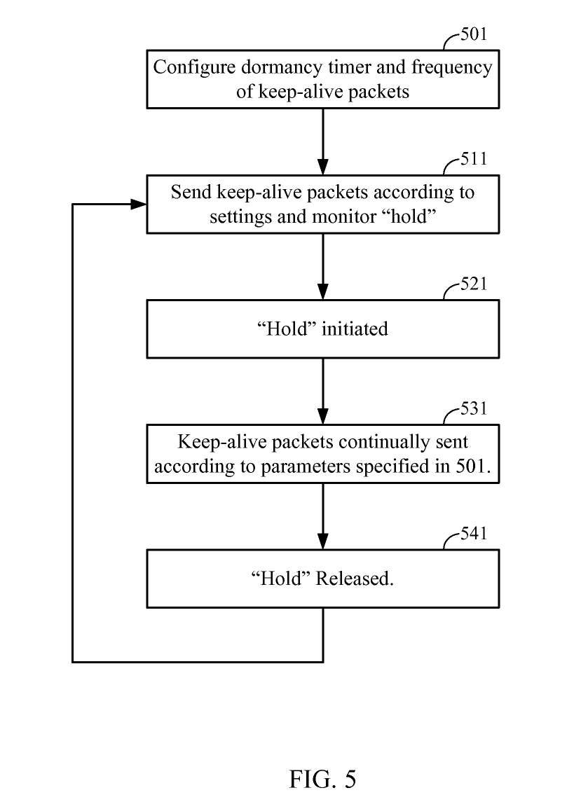

Referring to FIG. 5, a process flow is shown illustrating an exemplary embodiment of the call on hold process. In the exemplary embodiment of FIG. 5, it is assumed that a VoIP call is placed between two access terminals (e.g., AT 102 and AT 112). In this exemplary embodiment, RTCP keep-alive packets are transferred relatively frequently between both AT(s) and the RAN 120 in order to keep the radio channel active (e.g., even while the call is on hold). At some point during the call, assume AT 102 decides to place the VoIP call with AT 112 on hold. As described earlier, a VoIP call over an EV-DO Rev. A network will be dropped if the call is placed on hold for a duration of time that exceeds the traffic channel dormancy time threshold. However, since the RTCP keep-alive packets continue to be sent over the radio link even while the call is on hold, such that the dormancy timer is not exceeded, the radio link is maintained during the VoIP call on hold process. Subsequently, AT 102 decides to continue the conversation with AT 112 and presses the hold button again.

Further, it is understood that the circumstances for placing the call with AT 112 on hold may vary. In one embodiment, AT 102 may transmit/receive a call from another AT. However, in another embodiment, the reasons for placing the call on hold may include circumstances different than transmitting/receiving another call (e.g., a user of AT 102 is interrupted, user of AT 102 is in a relatively loud area, etc.). Additionally, it is noted that more than two AT(s) may be connected to each other and be placed on hold (e.g., if AT 102 is participating in a conference call with two or more other ATs).

At 501, the dormancy timer threshold of the RAN 120, AT 102 and AT 112, and the frequency at which the RTCP keep-alive packets are sent can be pre-configured or may be dynamically configured by the users of AT 102, 112, based on a setting from the RAN 120, and/or the Carrier 126. In an example, the dormancy timer threshold need not be the same at each of the network entities (e.g., AT 102, 112, RAN 120). In one embodiment, the frequency at which the RTCP keep-alive packets are sent is set such that successive RTCP keep-alive packets are sent prior to the expiration of the dormancy timer at least one of the RAN 120, AT 102 and AT 112. For example, a frequency that satisfies the dormancy timer requirements for all devices (e.g., a minimum dormancy period/smallest dormancy timer threshold) can be set for all devices. Alternatively, if longer dormancy periods are available, the frequency can be set for each device and may vary for different network entities.

In block 511, RTCP keep-alive packets are sent over the radio link between AT 102, 112 and the RAN 120. In this embodiment, AT 102 may initiate sending RTCP keep-alive packets to RAN 120. However, in another embodiment RAN 120 may initiate sending RTCP keep-alive packets to AT 102. RTCP keep-alive packets are configured to be part of the RTCP protocol. The RTCP protocol is utilized for QoS statistical data. Further, the hold status of each of the AT(s) engaged in the call can monitored for activity (e.g., monitoring a hold button), and reported to the RAN 120 and/or used to initiate a local process for maintaining the sending the RTCP keep-alive packets.

In block 521, a call hold is initiated (e.g., a user of AT 102 and/or AT 112 presses the hold button) in order to place the VoIP call between the AT 102 and AT 112 on hold. The hold button can be a physical button on the AT, softkey on the AT and/or can be a signal initiated from a device coupled to the AT (e.g., a button on a headset). Accordingly, the hold button can be any device capable of initiating and/or removing the hold.

In block 531, RTCP keep-alive packets are periodically sent between AT 102 and AT 112 at a given frequency (e.g., established such that the dormancy timer at each AT does not expire). This reduces the chance of the radio link from going down due to inactivity as traffic is sent over the radio link between AT 102, 112 and RAN 120 and the dormancy timer threshold is not exceeded. Accordingly, the dormancy timer does not expire resulting in the loss of the communication channel used for the VoIP call, as occurs in conventional systems.

In block 541, VoIP call on hold can be released. For example, the user may press the hold button again, release the hold button, etc. to indicate the hold should be released from the call and normal communication can continue. Accordingly, the call is taken off of hold and the process returns to 511.

Embodiment satisfies a number of criteria. For example, data sent as a keep-alive packet need not be real media that may be processed by the system as usable media, for example, data that may be heard by the other end-user while the VoIP call is on hold (e.g., music, etc.). For VoIP, the media data is contained in an RTP payload sent over an UDP/IP transport and control data is transported as RTCP control data over UDP/IP. Thus, if the keep-alive packets are sent as RTCP control data, then the other end-user may not necessarily notice the incoming control data.

In another example, the data sent as keep-alive packets need not be sent so frequent enough to result in delays of the delivery of the payload media data when the VoIP call is not on hold. However, the keep-alive packet data may be sent frequently enough to not exceed the expected dormancy time threshold while the VoIP call is on hold, which would result in the VoIP call on hold being dropped. For example, the dormancy timer for deployed networks may ranges between 10-30 seconds. In embodiments of the invention, the RTCP keep-alive packets can be configured to be sent at least every 20 seconds, and in other embodiments in the range of every 2 to 5 seconds. Thus, the RTCP keep-alive packets in this embodiment are frequent enough to prevent the dormancy timer from being exceeded due to inactivity, but at the same time not so frequent as to create delay for the RTP media packets. However, it will be appreciate that the foregoing example was provided merely for illustration and embodiments of the invention are not limited to these systems which use these example values.

In yet another example, the RTCP control data sent as keep-alive packets can be established such that they would not cause an unreasonable load on the carrier's network. In one example, the size of the RTCP control data sent as keep-alive packets can be less than seventy bytes (e.g., average around 68 bytes). Thus, the RTCP keep-alive packets in embodiments are generally not large enough (e.g., in the range of 60 to 80 bytes) to unreasonably burden the carrier's network. However, once again it will be appreciated that embodiments of the invention are not limited to this example. Further, it will be appreciated that different systems may use more or less bytes as can be tolerated by each system.

Further, the RTCP control data sent as keep-alive packets can be sent on the same RLP/MAC flow as that utilized for RTP in embodiments of the invention. Accordingly, another RLP/MAC flow need not be assigned to carry only RTCP keep-alive packets, which would be costly in terms of resources for both the Access Terminal and the Access Network. Thus, the RTCP keep-alive packets in some embodiments do not result in an additional RLP/MAC flow.

In still another example, the data sent as keep-alive packets may serve some useful purpose. Therefore, the data sent as keep-alive packets need not be used just to have arbitrary traffic on the air link. In this example embodiment, RTCP control data can be sent as keep-alive packets that include useful information. RTCP is a sister protocol of RTP, which can both utilized by the VoIP call. RTCP can provide out-of-band control information for an RTP flow. One function of RTCP is to provide feedback on the QoS being provided by RTP. For example, RTCP can be used to gather statistics on a media connection and information which may include but is not limited to, for example, bytes sent, packets sent, packets lost, jitter, and round trip delay. An application may use this information to increase the quality of service. For example, the quality of service may be increased limiting flow or using a different codec. In one example embodiment, the RTCP control data sent as keep-alive packets can be used for generating QoS performance metrics, which provides a useful purpose, aside from keeping the call from being dropped.

While the foregoing examples have described beneficial aspects of various embodiments of the invention, it will be appreciated that other embodiments of the invention can be directed to implementations that do not necessarily include all of the listed features and/or aspects. Thus, while these beneficial aspects have been described, they are not to be construed as being in all embodiments of the invention.

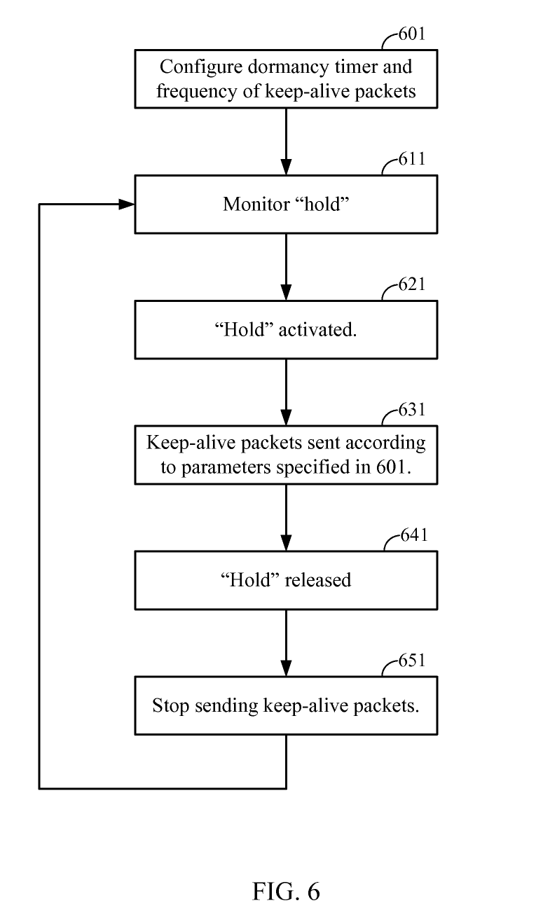

While the embodiment of FIG. 5 was described as directed towards RTCP keep-alive packets that were sent/received both while the call was active (i.e., not on hold) and on hold, it will be appreciated that other embodiments can be deployed. For example, the embodiment illustrated in FIG. 6 need not have AT 102 or 112 send/receive RTCP keep-alive packets while the call is active. In the embodiment of FIG. 6, a VoIP call is placed between AT 102 and AT 112. Afterwards, AT 102 decides to place the VoIP call with AT 112 on hold. Subsequently, the hold button acts as a trigger, which when pressed by either AT, causes RTCP keep-alive packets to be sent between both AT(s) preventing the radio link from being dropped.

Referring to FIG. 6, a process flow is shown that illustrates another exemplary embodiment of the call on hold process. At 601, the dormancy timer of the RAN 120, AT 102 and AT 112 and the frequency at which the RTCP keep-alive packets are sent can be preconfigured, and/or dynamically configured by at the AT (e.g., 102, 112), the RAN 120, and/or the Carrier 126. In an example, the frequency at which the RTCP keep-alive packets are sent is set such that successive RTCP keep-alive packets are sent prior to the expiration of the dormancy timer of at least one the RAN 120, AT 102 or AT 112.

In block 611, the hold status is monitored (e.g., a button of each of the AT(s) on the call is monitored for activity). In block 621, a call hold is activated (e.g., the user of AT 102 and/or AT 112 presses the hold button) in order to place the VoIP call between the AT 102 and AT 112 on hold. As noted in the foregoing, the “hold button” as used herein can be any device that can initiate and/or release the call hold (e.g., a physical button on AT 102 and/or 112).

In block 631, RTCP keep-alive packets are sent over the radio link between the AT(s) and the RAN 120. This prevents the radio link from going down as traffic is sent over the radio link between the AT(s) and RAN 120 and the dormancy timer expiration is not reached. RTCP keep-alive packets are configured to be part of the RTCP protocol. The RTCP protocol is utilized for QoS statistical data. In one embodiment, AT 102 may initiate sending RTCP keep-alive packets to RAN 120. However, in another embodiment RAN 120 may initiate sending RTCP keep-alive packets to AT 102.

In block 641, the call hold can be released (e.g., the user who initiated placing the VoIP call on hold presses the hold button again). Therefore, the call is taken off of hold and normal communication can continue. In block 651, RTCP packets are no longer sent over the radio link as keep-alive packets (e.g., in response to the call returning from hold to active status) and the process returns to 611.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying methods for preventing a VoIP call on hold from being dropped in an EV-DO system, as detailed in the foregoing application. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of reducing an occurrence of a Voice over Internet Protocol (VoIP) call from being disconnected in an Evolution Data Only (EV-DO) system, the method comprising:
placing the VoIP call on hold; and
issuing at least one keep-alive packet to prevent a radio link from disconnecting, at least while the VoIP call associated with the radio link is on hold, wherein the at least one keep-alive packet is configured to reset a dormancy timer for the call at one or more network entities.

2. The method of claim 1, wherein the at least one keep-alive packet includes control data.

3. The method of claim 2, wherein the control data includes Real Time Control Protocol (RTCP) packets.

4. The method of claim 3, wherein the RTCP packets are sent on a same Radio Link Protocol (RLP)/Media Access Control (MAC) flow as that utilized for a Real-time Transport Protocol (RTP).

5. The method of claim 1, wherein the at least one keep-alive packet size is configured so as not yield network delay for the delivery of payload data.

6. The method of claim 5, wherein the at least one keep-alive packet has a size of less than seventy bytes.

7. The method of claim 5, wherein the at least one keep-alive packet has a size in range of sixty bytes to eighty bytes.

8. The method of claim 1, wherein the at least one keep-alive packet includes a plurality of keep-alive packets that are sent at least every twenty seconds.

9. The method of claim 1, wherein the at least one keep-alive packet includes a plurality of keep-alive packets are sent in the range of two to five seconds.

10. The method of claim 1, wherein the one or more network entities includes an access terminal and/or an access network.

11. The method of claim 10, wherein the at least one keep-alive packet is sent between an access terminal and an access network.

12. The method of claim 1, wherein the issuing step issues a plurality of keep-alive packets, with at least one of the plurality of keep-alive packets being issued while the call is on hold and at least one of the plurality of keep-alive packets being issued while the call is not on hold.

13. The method of claim 1, wherein the issuing step only issues keep-alive packets while the call is on hold.

14. The method of claim 1, further comprising:
establishing a frequency at which the plurality of keep-alive packets are transmitted such that at least one keep-alive packet is transmitted before a dormancy timer threshold of the dormancy timer of the one or more network entities is expected to expire.

15. The method of claim 14, wherein the frequency is established based on the smallest timer threshold of the one or more network entities.

16. An apparatus comprising:
logic configured to place a Voice over Internet Protocol (VoIP) call on hold in an Evolution Data Only (EV-DO) system; and
logic configured to issue at least one keep-alive packet to prevent a radio link from disconnecting, at least while the VoIP call associated with the radio link is on hold, wherein the at least one keep-alive packet is configured to reset a dormancy timer for the call at one or more network entities.

17. The apparatus of claim 16, wherein the at least one keep-alive packet includes control data.

18. The apparatus of claim 17, wherein the control data includes Real Time Control Protocol (RTCP) packets.

19. The apparatus of claim 18, wherein the RTCP packets are sent on a same Radio Link Protocol (RLP)/Media Access Control (MAC) flow as that utilized for a Real-time Transport Protocol (RTP).

20. The apparatus of claim 16, wherein the at least one keep-alive packet has a size in range of sixty bytes to eighty bytes.

21. The apparatus of claim 16, wherein the at least one keep-alive packet includes a plurality of keep-alive packets are sent in the range of two to five seconds.

22. The apparatus of claim 16, wherein the apparatus is an access terminal or an access network.

23. The apparatus of claim 22, wherein the at least one keep-alive packet is sent between the access terminal and the access network.

24. The apparatus of claim 16, wherein the logic configured to issue is configured to issue a plurality of keep-alive packets, with at least one of the plurality of keep-alive packets being issued while the call is on hold and at least one of the plurality of keep-alive packets being issued while the call is not on hold.

25. The apparatus of claim 16, wherein the logic configured to issue is configured to only issue keep-alive packets while the call is on hold.

26. The apparatus of claim 16, further comprising:
logic configured to establish a frequency at which the plurality of keep-alive packets are transmitted such that at least one keep-alive packet is transmitted before a dormancy timer threshold of the dormancy timer of the one or more network entities is expected to expire.

27. The apparatus of claim 26, wherein the frequency is established based on the smallest timer threshold of the one or more network entities.

28. A computer-readable medium comprising instructions for reducing an occurrence of a Voice over Internet Protocol (VoIP) call from being disconnected in an Evolution Data Only (EV-DO) system, which, when executed by a machine, cause the machine to perform operations, the instructions comprising:
instruction to place the VoIP call on hold; and
instructions to issue at least one keep-alive packet to prevent a radio link from disconnecting, at least while the VoIP call associated with the radio link is on hold, wherein the at least one keep-alive packet is configured to reset a dormancy timer for the call at one or more network entities.

29. The computer-readable medium of claim 28, wherein the at least one keep-alive packet includes control data and wherein the control data includes Real Time Control Protocol (RTCP) packets.

30. The computer-readable medium of claim 29, wherein the RTCP packets are sent on a same Radio Link Protocol (RLP)/Media Access Control (MAC) flow as that utilized for a Real-time Transport Protocol (RTP).

31. The computer-readable medium of claim 28, wherein instructions to issue include instructions to issue a plurality of keep-alive packets, with at least one of the plurality of keep-alive packets being issued while the call is on hold and at least one of the plurality of keep-alive packets being issued while the call is not on hold.

32. The computer-readable medium of claim 28, wherein instructions to issue include instructions to only issue keep-alive packets while the call is on hold.

33. An apparatus comprising:
means for placing a Voice over Internet Protocol (VoIP) call on hold in an Evolution Data Only (EV-DO) system; and
means for issuing at least one keep-alive packet to prevent a radio link from disconnecting, at least while the VoIP call associated with the radio link is on hold, wherein the at least one keep-alive packet is configured to reset a dormancy timer for the call at one or more network entities.

34. The apparatus of claim 33, wherein the at least one keep-alive packet includes control data and wherein the control data includes Real Time Control Protocol (RTCP) packets.

35. The apparatus of claim 34, wherein the RTCP packets are sent on a same Radio Link Protocol (RLP)/Media Access Control (MAC) flow as that utilized for a Real-time Transport Protocol (RTP).
